(19) United States
(12) Patent Application Publication
(10) Pub. No.: US 2022/0316540 A1
(43) Pub. Date: Oct. 6, 2022

(54) Disc Brake Device

(71) Applicant: Hitachi Astemo, Ltd., Hitachinaka-shi,Ibaraki (JP)

(72) Inventors: Kohei MATSUSHITA, Tokyo (JP); Norio lSHITSUKA, Tokyo (JP); Hisashi TANIE, Tokyo (JP); Yusuke NlSHINO, Hitachinaka-shi, Ibaraki (JP)

(21) Appl. No.: 17/597,243

(22) PCT Filed: Jun. 8, 2020
(86) PCT No.: PCT/JP2020/022550

§ 371 Date: Dec. 30, 2021

(30) Foreign Application Priority Data
Jul. 4, 2019 (JP) 2019-125030

(51) Int. Cl. F16D 65/18

(52) U.S. Cl. CPC F16D 65/18; F16D 2125/04

(57) ABSTRACT

The present invention addresses the problem of providing a disc brake device for which sliding at the boundary surface between a piston and a piston seal is suppressed, and dragging is reduced. The present invention is provided with a cylinder, a piston housed in the cylinder, an inner brake pad opposing a disc rotor, an inner circumferential groove formed in a cylinder inner circumference, and a piston seal that is provided in the inner circumferential groove and contacts the piston. The inner circumferential groove is provided with a wall, a wall on the opposite side from the wall, a bottom wall connecting the wall and the wall, and a curved surface expanding the inner circumferential groove at the wall. The bottom wall is formed such that the distance to the piston gradually increases from the wall toward the wall. The curved surface is provided with a curvature starting point on the side closer to the piston seal and a curvature endpoint on the opposite side from the curvature starting point with the curved surface therebetween, and the curvature endpoint is positioned farther outside than the cylinder inner circumference.

### TECHNICAL FIELD

The present invention relates to a disc brake device arranged in an automobile and the like.

### BACKGROUND ART

A disc brake device used for an automobile and the like operates a piston arranged within a bore (cylinder) of a brake caliper by hydraulic pressure and the like, presses a brake lining (brake pad) to a friction ring (disc rotor), and obtains a braking force. The piston slides within the bore. A groove is formed in a part of the inner circumferential surface within the bore where the piston slides, and a seal ring preventing leakage of the pressure medium is arranged in the groove.

When the brake is operated and the piston is moved to the direction of the brake lining, the seal ring deforms following up the piston. When the brake is released, the piston is taken back by a restoring force of the seal ring having deformed, and, accompanying it, the brake lining moves to the direction of departing from the friction ring.

In order to improve the action of taking back the piston, there is a technology that the groove bottom portion of the groove is made to incline so as to approach the center axis of the cylinder (bore axis) as it goes toward the pressing direction of the piston. As such technology, a technology described in Patent Literature 1 is proposed.

### CITATION LIST

### Patent Literature

Patent Literature 1: JP-A No. 2009-535587

### SUMMARY OF INVENTION

### Technical Problem

However, in the technology described in Patent Literature 1, although the seal ring having deformed tried to return to the original position by the restoring force, in returning, the seal ring collided on the side surface of the groove formed on the opposite side of the brake lining (brake pad), and such state occurred that movement of the seal ring was restricted and the piston did not return sufficiently. As a result, there was a problem that the brake lining (brake pad) did not depart from the friction ring (disc rotor) sufficiently, the brake lining and the friction ring dragged each other in a contact state even when the brake was not operated, and the fuel economy was deteriorated.

The object of the present invention is to provide a disc brake device solving the problem described above, suppressing sliding at the boundary of the piston and the piston seal, and reducing dragging.

### Solution to Problem

In order to achieve the object described above, the present device is a disc brake device including a cylinder, a piston housed in the cylinder, and an inner brake pad arranged on one side of the piston and opposing a disc rotor, and is featured that an inner circumferential groove formed in an inner circumference of the cylinder and a piston seal that is provided in the inner circumferential groove and contacts the piston are provided, the inner circumferential groove includes a wall on the inner brake pad side, a wall on the opposite side of the inner brake pad, a bottom wall connecting the wall on the inner brake pad side and the wall on the opposite side, and a curved surface expanding the inner circumferential groove at the wall on the opposite side, the bottom wall is formed such that the distance to the piston gradually increases from the wall on the inner brake pad side toward the wall on the opposite side, the curved surface includes a curvature starting point on the side closer to the piston seal and a curvature endpoint on the opposite side from the curvature starting point, the curved surface being located between the curvature starting point and the curvature endpoint, and the curvature endpoint is positioned farther outside than the inner circumference of the cylinder.

### Advantageous Effects of Invention

According to the present invention, it is allowed to provide to provide a disc brake device suppressing sliding at the boundary surface between the piston and the piston seal, and reducing dragging.

### BRIEF DESCRIPTION OF DRAWINGS

FIG. 1 is a cross-sectional view of a disc brake device related to the first embodiment of the present invention.

FIG. 2 is a perspective view of a rotation/linear motion conversion mechanism portion of the disc brake device related to the first embodiment of the present invention.

FIG. 3 is a perspective view of a piston of the disc brake device related to the first embodiment of the present invention.

FIG. 4A is a cross-sectional view of a piston seal, an inner circumferential groove of a cylinder, and the piston of the disc brake device related to the first embodiment of the present invention.

FIG. 4B is an enlarged view of the portion A in FIG. 4A.

FIG. 5A is a cross-sectional view of a piston seal, an inner circumferential groove of a cylinder, and a piston of a disc brake device related to the second embodiment of the present invention.

FIG. 5B is an enlarged view of the portion A in FIG. 5A.

FIG. 6A is a cross-sectional view of a piston seal, an inner circumferential groove of a cylinder, and a piston of a disc brake device related to the third embodiment of the present invention.

FIG. 6B is an enlarged view of the portion A in FIG. 6A.

FIG. 7A is a cross-sectional view of a piston seal, an inner circumferential groove of a cylinder, and a piston of a disc brake device related to the fourth embodiment of the present invention.

FIG. 7B is an enlarged view of the portion A in FIG. 7A.

FIG. 8A is a cross-sectional view of a piston seal, an inner circumferential groove of a cylinder, and a piston of a disc brake device related to the fifth embodiment of the present invention.

FIG. 8B is an enlarged view of the portion A in FIG. 8A.

FIG. 9A is a cross-sectional view of a piston seal, an inner circumferential groove of a cylinder, and a piston of a disc brake device related to the sixth embodiment of the present invention.

FIG. 9B is an enlarged view of the portion A in FIG. 9A.

FIG. 10A is a cross-sectional view of a piston seal, an inner circumferential groove of a cylinder, and a piston of a disc brake device related to the seventh embodiment of the present invention.

FIG. 10B is an enlarged view of the portion A in FIG. 10A.

### DESCRIPTION OF EMBODIMENTS

Embodiments related to the present invention will be hereinafter explained in detail based on the drawings.

### First Embodiment

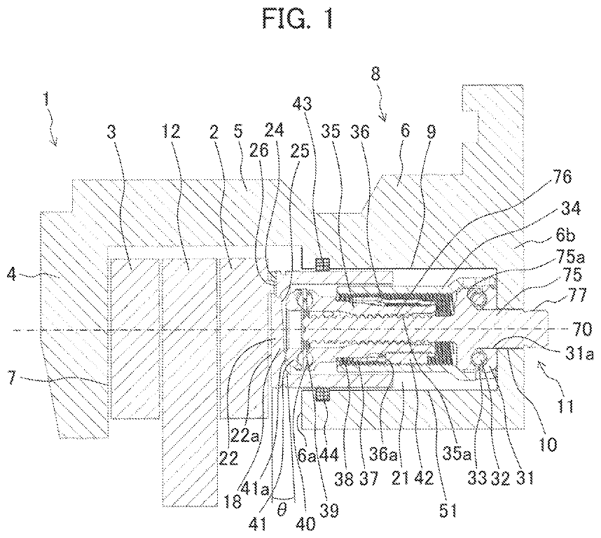

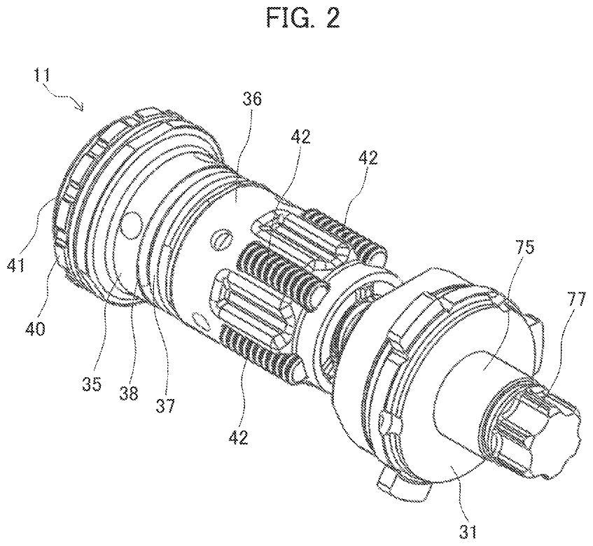

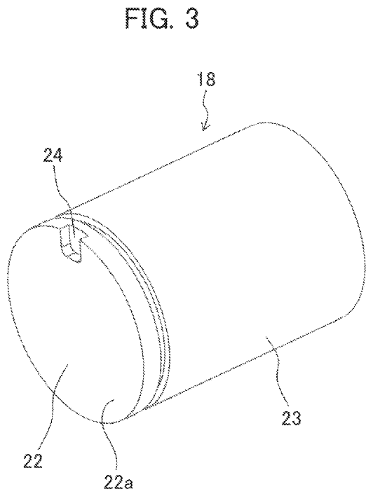

A basic configuration of the disc brake device of the present embodiment will be explained using FIGS. 1 to 3. FIG. 1 is a cross-sectional view of a disc brake device related to the first embodiment of the present invention. Also, a caliper body 8 is shown in a simplified construction. FIG. 2 is a perspective view of a rotation/linear motion conversion mechanism of the disc brake device related to the first embodiment of the present invention. Also, in order to explain the internal construction of the rotation/linear motion conversion mechanism 11, a nut roller 34 is not illustrated. FIG. 3 is a perspective view of a piston of the disc brake device related to the first embodiment of the present invention.

As shown in FIG. 1, a disc brake device 1 includes a pair of inner brake pad 2 and outer brake pad 3 arranged on both sides in the axial direction sandwiching a disc rotor 12 that is attached to a rotational portion of a vehicle, the caliper body 8, and the rotation/linear motion conversion mechanism 11. A pair of the inner brake pad 2 and the outer brake pad 3 and the caliper body 3 are supported by a bracket so as to be movable in the axial direction of the disc rotor 12, the bracket being fixed to a non-rotational portion of the vehicle. On one side (opposite side of the disc rotor) of the inner brake pad 2, a projection portion 26 is arranged. The projection portion 26 has a function of engaging with a recessed portion 24 arranged on the other end side surface of a piston 18 and preventing rotation of the piston 18.

For convenience of explanation, hereinafter, the right side (the opposite side of the caliper claw portion) of the drawing is expressed one end side, the left side (the caliper claw portion side) is expressed the other end side, the lower side is expressed the open side, and the upper side is expressed the root side.

The caliper body 8 includes a cylinder 6 arranged on the inner brake pad 2 side (one end side), a caliper claw portion 4 arranged on the outer brake pad 3 side (the other end side), and a disc path portion (saddling portion) 5 positioned between the cylinder 6 and the caliper claw portion 4.

A bore portion 9 opening to the inner brake pad 2 side is formed in the cylinder 6, and a hole portion 10 is arranged in a bottom wall 6b of the bore portion 9 positioned on one end side. The piston 18 is housed in the inner circumferential surface of the bore portion 9. The inner brake pad 2 is provided on one end side of the piston 18.

The disc path portion 5 is positioned on the root side of the cylinder 6, is extended to the other end side (the caliper claw portion 4 side) toward a rotation axis 70 direction of a spindle 75, straddles the disc rotor 12, and connects the cylinder 6 and the caliper claw portion 4 to each other. That is to say, the caliper claw portion 4 is supported by the cylinder 6 in a cantilever style by way of the disc path portion 5. The caliper claw portion 4 is positioned on the opposite side of the cylinder 6 side of the disc path portion 5, and is configured to extend to the direction perpendicular to the rotation axis 70 and to oppose the outer brake pad 3. That is to say, the caliper claw portion 4 is arranged on the opposite side of the piston 18 with respect to the disc rotor 12, and an inner surface (cylinder opposing surface) 7 of the caliper claw portion 4 and an inner surface (caliper claw portion opposing surface) 6a of the cylinder 6 oppose each other through the outer brake pad 3, the disc rotor 12, and the inner brake pad 2. The inner surface 7 of the caliper claw portion 4 is in a flat surface shape, and is perpendicular to the rotation axis 70. Also, the inner surface 7 of the caliper claw portion 4 opposes a flat surface portion 22a of the piston 18 through the outer brake pad 3, the disc rotor 12, and the inner brake pad 2.

In the disc brake device 1, when an ordinary hydraulic brake is operated, the piston 18 is made to advance to the disc rotor 12 side by a brake fluid supplied to a hydraulic chamber 21 within the bore portion 9, the inner brake pad 2 is pressed by this piston 18, the disc rotor 12 is sandwiched along with the outer brake pad 3, and thereby a thrust force that is a brake force is generated.

The piston 18 is inserted into the bore portion 9 of the cylinder 6 so as to be slidable in the rotation axis 70 direction, and a bottom portion 22 is arranged so as to oppose a surface on one end side of the inner brake pad 2 as shown in FIG. 1. As shown in FIGS. 1 and 3, the piston 18 is formed into a bottomed cup shape including the bottom portion 22 and a cylindrical portion 23. When the piston 18 advances to the disc rotor 12 side, a piston seal 43 loaded to an inner circumferential groove 44 formed in the inner wall (cylinder inner circumference 51) of the cylinder 6 contacts the piston 18, elastically deforms by friction against the boundary surface between the piston 18 and hydraulic pressure, and follows up the piston 18. When the hydraulic brake is released, elastic deformation of the piston seal 43 is released, and the piston 18 returns by a restoring force of the piston seal 43 to the position of the time before the hydraulic brake is operated. Gaps are generated between the disc rotor 12, the inner brake pad 2, and the outer brake pad 3, and the brake force is released.

The flat surface portion (end surface portion) 22a on the other end side of the piston bottom portion 22 is a flat surface perpendicular to the rotation axis 70 and extending in parallel to the disc rotor 12. On the other hand, a flat surface portion (end surface portion) 25 on one end side of the piston bottom portion 22, namely the flat surface portion 25 opposing the rotation/linear motion conversion mechanism 11, has a shape inclining with respect to the rotation axis 70 as shown in FIG. 1, and thickness of the bottom portion 22 becomes thicker toward the opening side. In the present embodiment, the flat surface portion 25 inclines by 3° (θ=3°) with respect to the line perpendicular to the rotation axis 70 so as to open toward the open side. Also, as shown in FIG. 3, the recessed portion 24 is arranged by one position on the outer circumferential side of the other end surface opposing the inner brake pad 2 of the piston bottom portion 22. This recessed portion 24 engages with the projection portion 26 of the inner brake pad 2, and executes rotation prevention in the rotational direction and position determination of the piston 18. With respect to the position in the circumferential direction of the recessed portion 24, the recessed portion 24 is arranged at a position where the piston bottom portion 22 becomes thinnest. With respect to the disposal position in the circumferential direction of the piston 18, the piston 18 is arranged so that the recessed portion 24 comes to the root side as shown in FIG. 1. In this case, the flat surface portion 25 of the piston inner surface inclines so that the open side approaches the cylinder side (namely one end side). That is to say, the flat surface portion 25 of the piston inner surface inclines so that, compared to the root side, the open side approaches the rotation/linear motion conversion mechanism 11 or the opening side of the piston 18.

Next, explanation will be made on the rotation/linear motion conversion mechanism 11. The rotation/linear motion conversion mechanism 11 shown in the present embodiment is a mechanism featured to use a roller 42, and will be hereinafter referred to as a roller type mechanism.

The rotation/linear motion conversion mechanism 11 converts rotation of an electric motor not illustrated to motion in the linear direction (will be hereinafter referred to as linear motion), imparts a thrust force to the piston 18, and holds the piston 18 at the braking position. The rotation/linear motion conversion mechanism 11 is housed between the bottom wall 6b of the cylinder 6 and the flat surface portion 25 of the piston inner surface. That is to say, the rotation/linear motion conversion mechanism 11 is supported by the cylinder 6 of the caliper body 8 along with the piston 18. Explanation will be hereinafter made on configuring components.

A plate base 31 is fixed in the bottom wall 6b of the cylinder 6 by a pin not illustrated, and is prevented from rotation with respect to the nut roller 34. The plate base 31 is formed into a disc shape, and a hole portion 31a is worked at the center in the radial direction of the disc shape, the spindle 75 being installed in the hole portion 31a.

The spindle 75 is configured as a rotation transmission member to which rotation of the electric motor is transmitted and is supported so as to be rotatable with respect to the cylinder 6 and the plate base 31, and rotational motion from the electric motor is transmitted to the spindle 75 through a gear unit not illustrated. A thread portion 76 is formed on the outer circumferential surface on the other end side of the spindle 75, and is screw-fitted to a shaft roller 35, a thread portion 35a being formed on the inner circumferential surface of the shaft roller 35. By rotation of the spindle 75 to the applying direction, the shaft roller 35 having been screw-fitted advances to the direction of the other end side.

On one end side of the spindle 75, a polygonal shape portion 77 is formed. By connection of this portion to the gear unit not illustrated, rotational torque of the electric motor can be transmitted.

The roller 42 has an annular mountain shape, is fitted to an annular groove portion on the outer circumferential surface of the shaft roller 35 in the annular mountain portion of the roller 42, and is held so as to be rotatable in the axial direction. Also, the roller 42 is fitted to a thread mountain portion on the inner circumferential surface of the nut roller 34 in the annular mountain portion of the roller 42, and is held so as to be rotatable in the axial direction. The roller 42 is disposed by plural number of pieces in the circumferential direction of the outer circumferential surface of the shaft roller 35.

The nut roller 34 is fitted to the plate base 31 in the radial direction, and is prevented from rotation. The inner surface of the nut roller 34 is subjected to threading work, and the roller 42 is held at this threaded portion. A cage roller 36 is disposed on the outer circumferential surface of the shaft roller 35, and includes plural number of pieces of elongated hole portion 36a. The roller 42 is disposed in this elongated hole portion 36a. The end surface on the other end side of the elongated hole portion 36a and the end surface of the roller 42 contact each other, and a spring load described below is transmitted to the roller 42. The elongated hole portion 36a contacts the contour portion of the roller 42 in the circumferential direction.

The end surface on the other end side of the cage roller 36 slides against a plate spring 37. With respect to the plate spring 37, the left end surface contacts a spring 38, and the right end surface contacts the cage roller 36. The plate spring 37 has a function of transmitting precompression of the spring 38 to the cage roller 36. The spring 38 is positioned on the outer circumferential surface (the outer circumference side) of the shaft roller 35, and imparts precompression to the cage roller 36 in the axial direction.

In the shaft roller 35, the inner surface portion is subjected to threading work, and the outer circumferential portion is subjected to annular groove work. Here, the inner surface portion is screw-fitted to the spindle 75, and the annular groove of the outer circumferential portion is fitted to the annular mountain portion of the roller 42. A groove portion for ball thrust is formed on the other end side of the shaft roller 35, and holds a retainer thrust 40 and a ball thrust 39 in a gap against a plate thrust 41. The roller 42 is held in the axial direction by the annular groove and is made turnable, an axial force from the ball groove portion is transmitted to the roller 42 in applying, and a reaction force from the roller 42 is transmitted to the thread portion in releasing.

The annular mountain portion of the roller 42 described above is formed as an annular mountain portion (projection portion) on the outer circumferential surface of the roller 42, and the annular groove of the shaft roller 35 described above is formed as an annular groove portion (recessed portion) on the outer circumferential surface of the shaft roller 35. The annular mountain portion of the roller 42 and the annular groove of the shaft roller 35 have the width and the interval which allow mutual engagement.

A one end side ball thrust 32 is positioned between a ball groove portion 75a of the spindle 75 and the plate base 31, and transmits an axial force from the spindle 75 to the plate base 31 while it rotates. The other end side ball thrust 39 is positioned between the plate thrust 41 and the shaft roller 35, and rotates the shaft roller 35. Also, the other end side ball thrust 39 has a function of transmitting a thrust force from the plate thrust 41 to the shaft roller 35 side.

A one end side retainer thrust 33 is positioned between the ball groove portion 75a and the plate base 31, and holds the one end side ball thrust 32. The other end side retainer thrust 40 is positioned between the ball groove portion and the plate thrust 41, and holds the other end side ball thrust 39.

Next, a motion mechanism in operating the electric brake device will be explained using FIG. 1.

When the brake is applied using the electric motor, an ECU drives the electric motor and rotates various gears. By this rotation of the gears, rotation of the electric motor is transmitted to the spindle 75. Next, by rotation of the spindle 75 to the applying direction, the shaft roller 35 advances toward the inner surface side (the bottom portion 22 side) of the piston 18 along the direction of the rotation axis 70. As a result, the other end side ball thrust 39, the distal end side retainer thrust 40, and the plate thrust 41 advance toward the inner surface portion of the piston 18 along the direction of the rotation axis 70 in an integral manner, and a pressing portion 41a of the plate thrust 41 abuts upon the inner surface portion of the piston 18. By this abutment, the piston 18 advances and the flat surface portion (end surface portion) 22a on the other side of the piston 18 abuts upon the inner brake pad 2.

Further, when rotation drive of the electric motor to the applying direction is continued, the piston 18 presses the inner brake pad 2 by movement of the shaft roller 35, sandwiches the disc rotor 12 along with the outer brake pad 3, and thereby generates a thrust force that is a braking force. When the piston 18 advances, the piston seal 43 loaded to the inner circumferential groove 44 of the cylinder 6 elastically deforms by friction against the boundary surface between the piston 18 and follows up the piston 18.

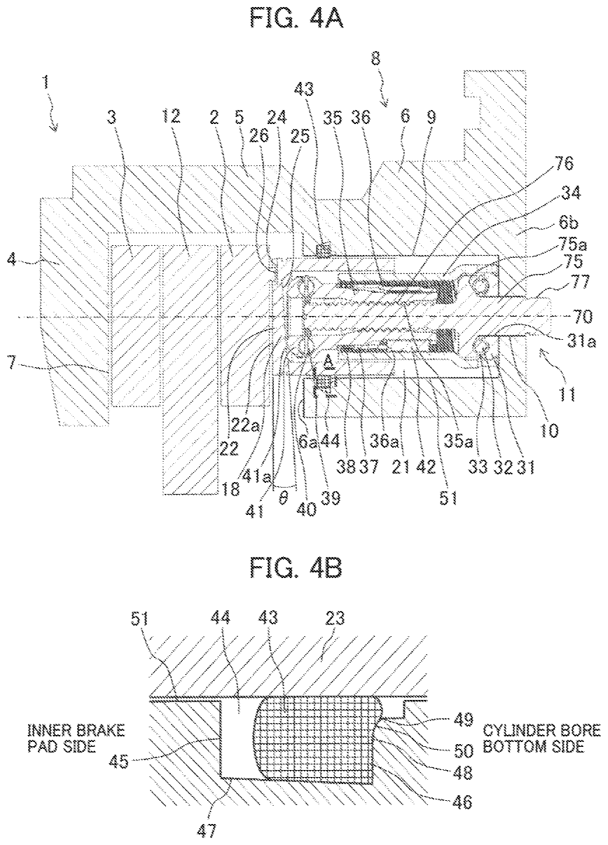

When the hydraulic brake is released, elastic deformation of the piston seal 43 is released, and the piston 18 returns to the position of the time before the hydraulic brake is applied. Compared to the case of the hydraulic brake, in the case of the electric brake, since hydraulic pressure is not applied to the piston seal 43, the piston seal 43 hardly follows up the piston 18 and hardly deforms elastically. Compared to the state after releasing the hydraulic brake, in the electric brake, the restoring force generated in the piston 18 from the piston seal 43 after releasing the electric brake is smaller, and the piston 18 hardly returns to the position of the time before the brake is applied. As a result, the gaps generated between the disc rotor 12, the inner brake pad 2, and the outer brake pad 3 become smaller. When these gaps are narrow, there is a problem that the disc rotor 12, the inner brake pad 2, and the outer brake pad 3 drag each other while they are in contact with each other, and the fuel economy is deteriorated. Countermeasures for solving it will be explained using FIG. 4.

FIG. 4A is a cross-sectional view of the piston seal, the inner circumferential groove of the cylinder, and the piston of the disc brake device related to the first embodiment of the present invention. FIG. 4B is an enlarged view of the portion A in FIG. 4A.

The disc brake device includes the cylinder 6, the piston 18, the inner brake pad 2, and the outer brake pad 3, the piston 18 being housed in the cylinder 6, the inner brake pad 2 and the outer brake pad 3 being arranged on one end side of the piston 18 and opposing the disc rotor 12.

In the boundary surface of the inner wall of the cylinder 6 (the cylinder inner circumference 51) against the piston 18, the inner circumferential groove 44 is arranged. In the inner circumferential groove 44, the piston seal 43 is housed, the piston seal 43 being wound around the piston 18 and energizing the piston 18 to the opposite side of the outer brake pad 3. The inner circumferential groove 44 includes a wall 45 on the inner brake pad side, a wall 46 on the opposite side (cylinder bore bottom side) of the inner brake pad, and a bottom wall 47.

The bottom wall 47 is formed so that the distance to the piston 18 (the cylinder inner circumference 51) gradually increases from the wall 45 on the inner brake pad side toward the wall 46 on the opposite side of the inner brake pad. To the contrary, it is formed so that the distance to the piston 18 (the cylinder inner circumference 51) gradually reduces from the wall 46 on the opposite side of the inner brake pad toward the wall 45 on the inner brake pad side.

The wall 46 on the opposite side (the cylinder bore bottom side) of the inner brake pad includes a curved surface 50 that expands the cylinder inner circumferential groove 44.

The curved surface 50 includes a curvature starting point 48 on the side closer to the piston seal 43 and a curvature endpoint 49 on the opposite side from the curvature starting point 48 with the curved surface 50 therebetween, and is formed so that the curvature endpoint 49 is positioned farther outside (outer circumferential side) than the cylinder inner circumference 51.

While the electric brake is operated, the piston seal 43 moves so as to approach the wall 45 on the inner brake pad side while the piston seal 43 is shear-deformed by a friction force generated at the boundary surface between the piston seal 43 and the piston 18. Since the bottom wall 47 is formed so that the distance to the cylinder inner circumference 51 gradually reduces from the wall 46 on the opposite side of the inner brake pad toward the wall 45 on the inner brake pad side, as the piston seal 43 moves toward the wall 45, the compression force applied in the radial direction of the piston seal 43 increases, the friction force increases, and therefore the piston seal 43 easily follows up the piston 18.

According to the first embodiment, since the piston seal 43 easily follows up the piston 18, even after releasing the electric brake, the restoring force generated from the piston seal 43 to the piston 18 can be increased, and the piston 18 can easily return to the position of the time before the brake is applied.

Also, according to the first embodiment, since the curved surface 50 includes the curvature starting point 48 on the side closer to the piston seal 43 and the curvature endpoint 49 on the opposite side from the curvature starting point 48 with the curved surface 50 therebetween and is formed so that the curvature endpoint 49 is present farther outer circumferential side than the cylinder inner circumference 51, the deformation allowance of the piston seal 43 in being restored toward the wall 46 on the opposite side increases (the piston seal 43 goes beyond the position of the wall 46 on the opposite side) after releasing the electric brake, and therefore the piston 18 can more easily returns to the position of the time before the brake is applied.

As described above, according to the first embodiment, it is allowed to provide a disc brake device controlling elastic deformation of the piston seal, suppressing sliding at the boundary surface between the piston and the piston seal, and reducing dragging.

### Second Embodiment

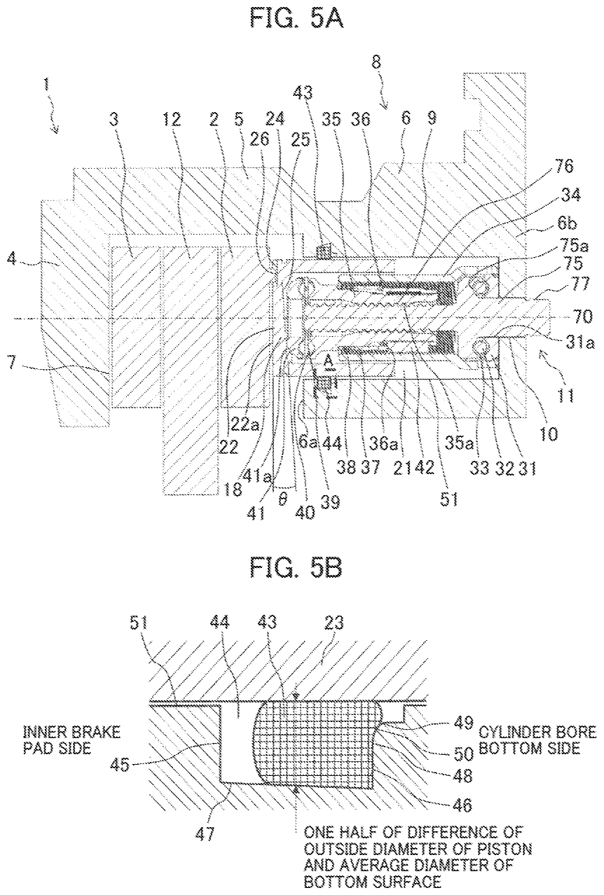

Next, the second embodiment of the present invention will be explained using FIG. 5. FIG. 5A is a cross-sectional view of a piston seal, an inner circumferential groove of a cylinder, and a piston of a disc brake device related to the second embodiment of the present invention. FIG. 5B is an enlarged view of the portion A in FIG. 5A. A configuration same to that of the first embodiment will be marked with a same reference sign, and detailed explanation thereof will be omitted.

In addition to the configuration of the first embodiment, the second embodiment is configured as described below. When the piston seal 43 is viewed in the cross section as shown in FIG. 5B, the bottom wall 47 is formed to incline so that one half of difference of the outside diameter of the piston 18 and the average diameter of the bottom wall 47 becomes smaller than natural length in the radial direction of the piston seal 43 by equal to or greater than 10%.

When it is formed so that one half of difference of the outside diameter of the piston 18 and the average diameter of the bottom wall 47 becomes smaller than natural length in the radial direction of the piston seal 43 by equal to or greater than 10%, the compression force applied in the radial direction of the piston seal 43 can be increased exponentially. Therefore, according to the second embodiment, the friction force between the piston 18 and the piston seal 43 is maintained high, and the piston seal 43 can easily follow up the piston 18.

### Third Embodiment

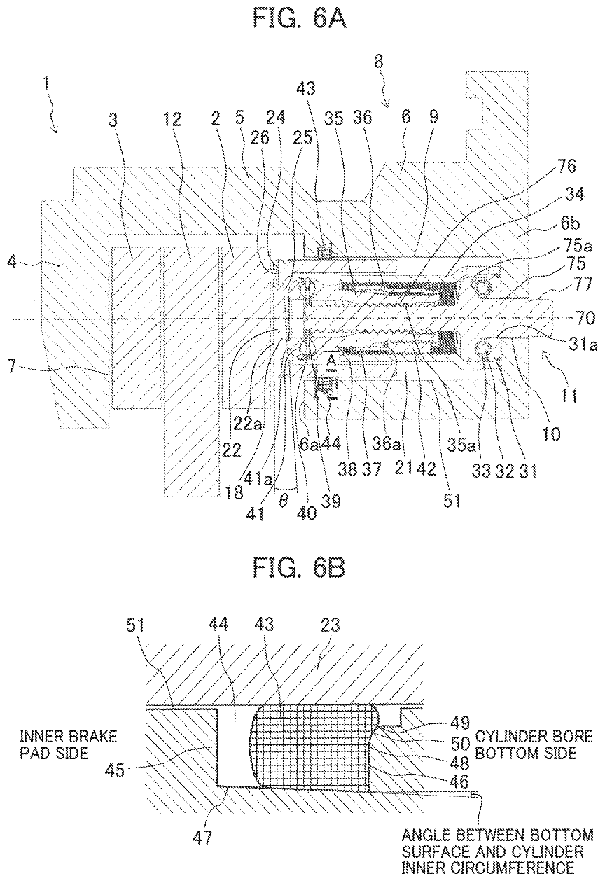

Next, the third embodiment of the present invention will be explained using FIG. 6. FIG. 6A is a cross-sectional view of a piston seal, an inner circumferential groove of a cylinder, and a piston of a disc brake device related to the third embodiment of the present invention. FIG. 6B is an enlarged view of the portion A in FIG. 6A. A configuration same to that of the first embodiment and the second embodiment will be marked with a same reference sign, and detailed explanation thereof will be omitted.

In addition to the configuration of the first embodiment and the second embodiment, in the third embodiment, it is formed so that the angle between the bottom wall 47 and the cylinder inner circumference 51 becomes equal to or greater than 2 degrees.

According to the third embodiment, since it is formed so that the angle between the bottom wall 47 and the cylinder inner circumference 51 becomes equal to or greater than 2 degrees, when the electric brake is operated, as the piston seal 43 moves toward the wall 45 on the inner brake pad side, the compression force can be increased more efficiently, and the piston seal 43 can easily follow up the piston 18.

### Fourth Embodiment

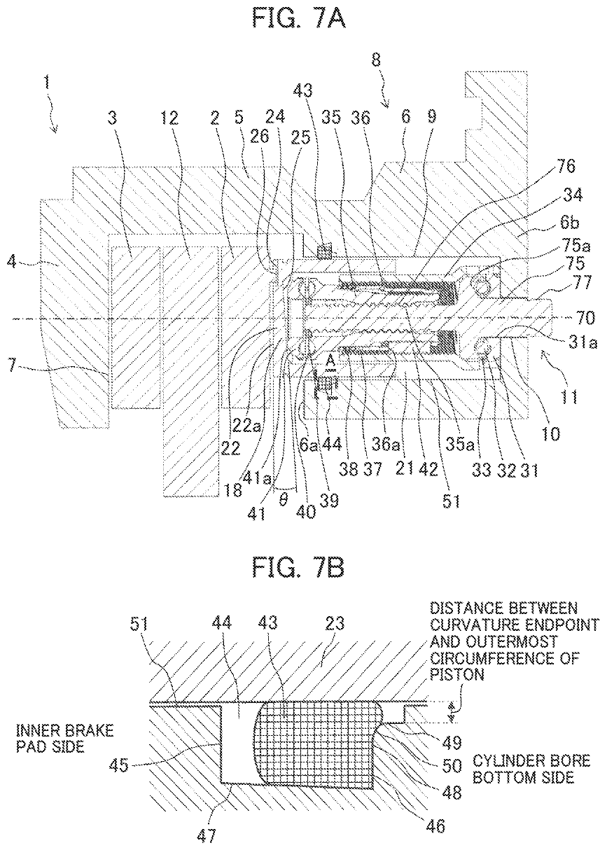

The fourth embodiment of the present invention will be explained using FIG. 7. FIG. 7A is a cross-sectional view of a piston seal, an inner circumferential groove of a cylinder, and a piston of a disc brake device related to the fourth embodiment of the present invention. FIG. 7B is an enlarged view of the portion A in FIG. 7A. A configuration same to that of the first to the third embodiments will be marked with a same reference sign, and detailed explanation thereof will be omitted.

In addition to the configuration of the first to the third embodiments, in the fourth embodiment, it is formed so that the distance between the curvature endpoint 49 and the outermost circumference of the piston 18 becomes equal to or greater than 0.3 times of the difference of the maximum radius of the bottom wall 47 and the radius of the outermost circumference of the piston 18.

According to the fourth embodiment, since it is formed so that the distance between the curvature endpoint 49 and the outermost circumference of the piston 18 becomes equal to or greater than 0.3 times of the difference of the maximum radius of the bottom wall 47 and the radius of the outermost circumference of the piston 18, after the electric brake is released, the deformation allowance of the piston seal 43 in being restored toward the wall 46 on the opposite side increases, and the piston 18 can return more efficiently to the position of the time before the brake is applied.

### Fifth Embodiment

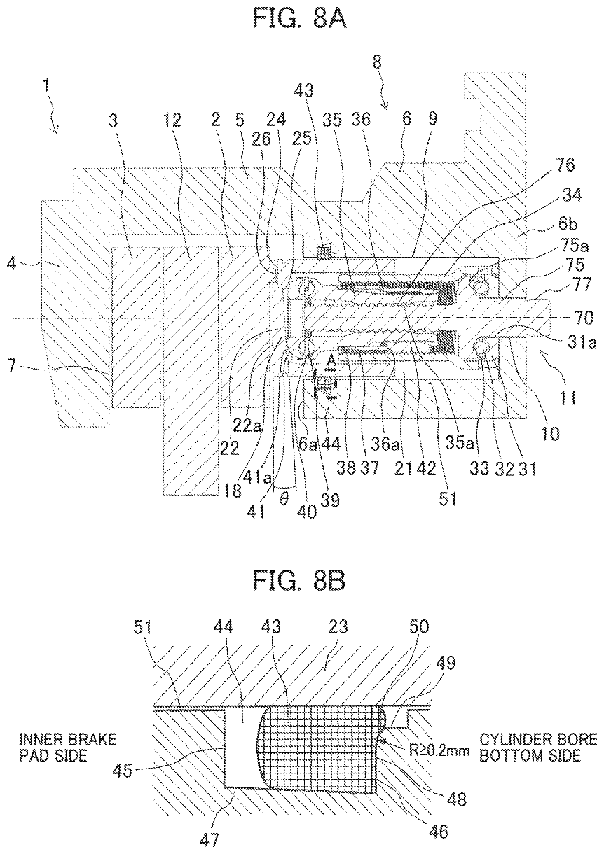

Next, the fifth embodiment of the present invention will be explained using FIG. 8. FIG. 8A is a cross-sectional view of a piston seal, an inner circumferential groove of a cylinder, and a piston of a disc brake device related to the fifth embodiment of the present invention. FIG. 8B is an enlarged view of the portion A in FIG. 8A. A configuration same to that of the first to the fourth embodiments will be marked with a same reference sign, and detailed explanation thereof will be omitted.

In addition to the configuration of the first to the fourth embodiments, in the fifth embodiment, it is formed so that the radius R of the curved surface 50 becomes equal to or greater than 0.2 mm.

According to the fifth embodiment, since it is formed so that the radius R of the curved surface 50 becomes equal to or greater than 0.2 mm, such event can be suppressed that the stress is concentrated when the piston seal 43 contacts the curved surface 50, and the piston 18 can return more efficiently to the position of the time before the brake is applied after the electric brake is released.

### Sixth Embodiment

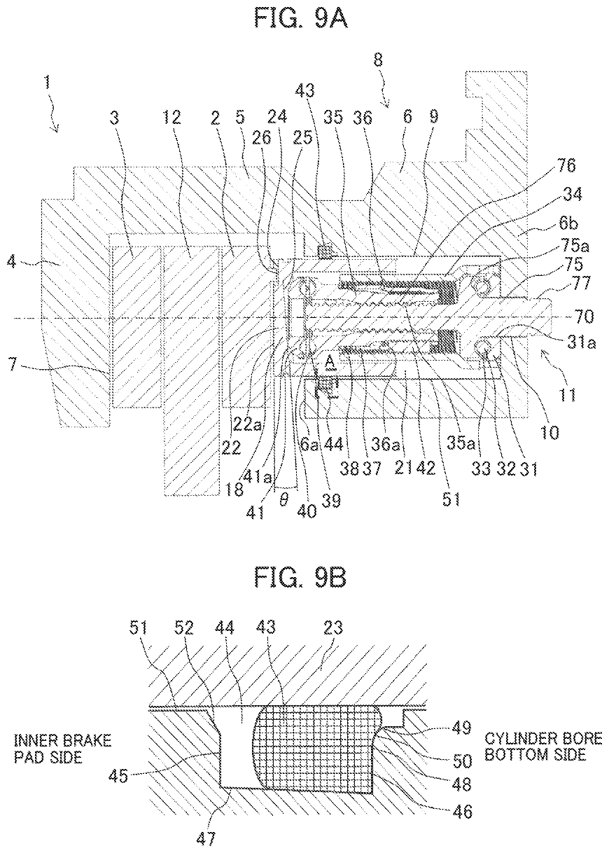

Next, the sixth embodiment of the present invention will be explained using FIG. 9. FIG. 9A is a cross-sectional view of a piston seal, an inner circumferential groove of a cylinder, and a piston of a disc brake device related to the sixth embodiment of the present invention. FIG. 9B is an enlarged view of the portion A in FIG. 9A. A configuration same to that of the first to the fifth embodiments will be marked with a same reference sign, and detailed explanation thereof will be omitted.

In addition to the configuration of the first to the fifth embodiments, in the sixth embodiment, an opening portion 52 having a tapered shape is formed between the wall 45 on the inner brake pad side and the cylinder inner circumference 51. The opening portion 52 inclines so as to expand to the inner brake pad side from the wall 45 on the inner circumferential groove 44 over to the cylinder inner circumference 51.

According to the sixth embodiment, since the opening portion 52 having a tapered shape is formed between the wall 45 on the inner brake pad side and the cylinder inner circumference 51, the deformation allowance of the piston seal 43 is added to the inner brake pad side, and the piston seal 43 can follow up the piston more easily while the electric brake is operated.

### Seventh Embodiment

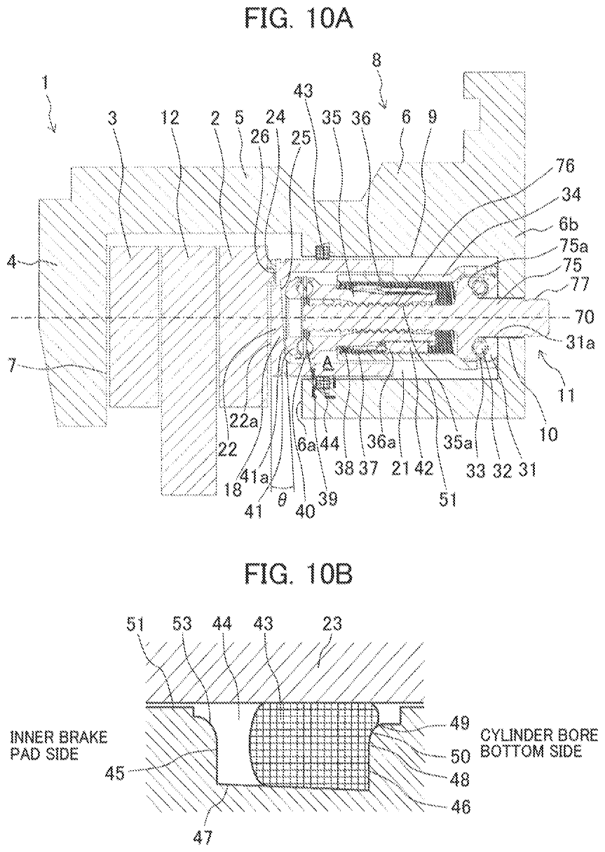

Next, the seventh embodiment of the present invention will be explained using FIG. 10. FIG. 10A is a cross-sectional view of a piston seal, an inner circumferential groove of a cylinder, and a piston of a disc brake device related to the seventh embodiment of the present invention. FIG. 10B is an enlarged view of the portion A in FIG. 10A. A configuration same to that of the first to the fifth embodiments will be marked with a same reference sign, and detailed explanation thereof will be omitted.

In addition to the configuration of the first to the fifth embodiments, in the seventh embodiment, a curved surface 53 expanding the inner circumferential groove 44 is formed between the wall 45 on the inner brake pad side and the cylinder inner circumference 51. The curved surface 53 curves so as to expand to the inner brake pad side from the wall 45 of the inner circumferential groove 44 over to the cylinder inner circumference 51.

According to the seventh embodiment, since it is configured to form the curved surface 53 expanding the inner circumferential groove 44 between the wall 45 on the inner brake pad side and the cylinder inner circumference 51, the deformation allowance of the piston seal 43 is added to the inner brake pad side, and therefore the piston seal 43 can follow up the piston easily while the electric brake is operated. Also, according the seventh embodiment, such event can be suppressed that the stress is concentrated when the piston seal 43 contacts the curved surface 50.

### LIST OF REFERENCE SIGNS

1: disc brake device, 2: inner brake pad, 3: outer brake pad, 4: caliper claw portion, 5: disc path portion, 6: cylinder, 7: inner surface of caliper claw portion, 8: caliper body, 9: bore portion, 10: hole portion, 11: rotation/linear motion conversion mechanism, 12: disc rotor, 18: piston, 19: bore portion, 21: hydraulic chamber, 22: bottom portion, 23: cylindrical portion, 24: recessed portion, 25: flat surface portion, 26: projection portion, 27: piston inner circumferential groove, 28: projection portion, 31: plate base, 32: one end side ball thrust, 33: one end side retainer thrust, 34: nut roller, 35: shaft roller, 36: cage roller, 37: plate spring, 38: spring, 39: ball thrust, 40: retainer thrust, 41: plate thrust, 42: roller, 43: piston seal, 44: inner circumferential groove, 45: wall, 46: wall, 47: bottom wall, 48: curvature starting point, 49: curvature endpoint, 50: curved surface, 51: cylinder inner circumference, 52: opening portion, 53: curved surface, 70: rotation axis, 75: spindle, 76: thread portion, 77: polygonal shape portion

1. A disc brake device, comprising:
a cylinder;
a piston housed in the cylinder; and
an inner brake pad arranged on one side of the piston and opposing a disc rotor, wherein
an inner circumferential groove formed in an inner circumference of the cylinder and a piston seal that is provided in the inner circumferential groove and contacts the piston are provided,
the inner circumferential groove includes a wall on the inner brake pad side, a wall on the opposite side of the inner brake pad, a bottom wall connecting the wall on the inner brake pad side and the wall on the opposite side, and a curved surface expanding the inner circumferential groove at the wall on the opposite side,
the bottom wall is formed such that the distance to the piston gradually increases from the wall on the inner brake pad side toward the wall on the opposite side,
the curved surface includes a curvature starting point on the side closer to the piston seal and a curvature endpoint on the opposite side from the curvature starting point, the curved surface being located between the curvature starting point and the curvature endpoint, and
the curvature endpoint is positioned farther outside than the inner circumference of the cylinder.

2. The disc brake device according to claim 1, wherein
one half of difference of outside diameter of the piston and average diameter of the bottom wall is formed to be smaller than natural length in the radial direction of the piston seal by equal to or greater than 10%.

3. The disc brake device according to claim 1, wherein
angle between the bottom wall and inner circumference of the cylinder is formed to be equal to or greater than 2 degrees.

4. The disc brake device according to claim 1, wherein
distance between the curvature endpoint and outermost circumference of the piston is formed to be equal to or greater than 0.3 times of difference of maximum radius of the bottom wall and radius of the outermost circumference of the piston.

5. The disc brake device according to claim 1, wherein
radius R of the curved surface is formed to be equal to or greater than 0.2 mm.

6. The disc brake device according to claim 1, wherein
an opening portion having a tapered shape is formed between the wall on the inner brake pad side and inner circumference of the cylinder.

7. The disc brake device according to claim 1, wherein
a curved surface expanding the inner circumferential groove is formed between the wall on the inner brake pad side and inner circumference of the cylinder.
